(19) United States
(12) Patent Application Publication
(10) Pub. No.: US 2010/0245757 A1
(43) Pub. Date: Sep. 30, 2010

(54) EYEGLASS-MOUNTED TYPE IMAGE DISPLAY DEVICE

(75) Inventors: Ryohei SUGIHARA, Tokyo (JP); Seiji TATSUTA, Tokyo (JP); Yoichi IBA, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/730,565

(22) Filed: Mar. 24, 2010

(30) Foreign Application Priority Data
Mar. 25, 2009 (JP) 2009-074429

(51) Int. Cl. G02C 11/00

(52) U.S. Cl. 351/158

(57) ABSTRACT

An eyeglass-mounted type image display device which is applicable to an existing pair of eyeglasses and includes an eyepiece optical unit arranged in a field of view of one eyeball of an observer and an image display unit having a display element for displaying an image is provided, wherein an image light emitted from the image display unit is incident on an eyeball through the eyepiece optical unit and at least one of the image display unit and the eyepiece optical unit is fixed and held to a hinge unit that foldably supports a temple with respect to a frame.

### CROSS-REFERENCE TO RELATED APPLICATION

The present application claims priority from Japanese Application No. 2009-74429 filed on Mar. 25, 2009, the content of which is incorporated herein by reference.

### FIELD OF THE INVENTION

The present invention relates to an eyeglass-mounted type image display device, which can be applied to a conventional pair of eyeglasses easily.

### BACKGROUND OF THE INVENTION

In the eyeglass-mounted type image display device, an image light emitted from an image display unit (unit body part) that is attached to a temple part of a pair of eyeglasses is incident on an eyeball of an observer through an eyepiece optical unit such as a light guiding unit, thereby enabling the image light to be observed as an image. As the conventional art with respect to this point, for example, JP 2005-352024 A suggests an eyeglass type interface device, in which a camera unit for taking an image of an amphiblestrode of the user and outputting an imaging signal, a wireless communication unit for transmitting the imaging signal from the camera unit through radio waves and a power generating unit for supplying electrical power to the camera unit and the wireless communication unit are mounted respectively on the pair of eyeglasses for integration.

Further, as other conventional eyeglass-mounted type image display devices, various types of devices are suggested so far. For example, JP 3871188 B2 suggests an eyeglass-mounted type image display device having a structure in which a housing assembly that contains a circuit configuration for receiving data or image that is relayed to the display device is mounted on a temple for a pair of eyeglasses of the user by a clamping assembly which clamps the housing assembly to a fitting, and JP 2008-22362 A suggests a structure in which an image formation projection device in the shape that does not mechanically interfere with an eyeglass lens is held to a temple.

However, in the conventional image display device of this type, an optical unit is embedded in a lens part of a pair of eyeglasses. Therefore an existing pair of eyeglasses cannot be used. Further, even if an optical unit has a foldable structure, folding work of the optical unit is required separately from the folding work of a temple, which causes trouble such as unavoidable troublesome works for housing. Thus there is still room for improvement.

The object of the present invention is to suggest an eyeglass-mounted type image display device that enables easy application to an existing pair of eyeglasses and a temple to be folded in a compact state as well.

### SUMMARY OF THE INVENTION

The present invention relates to an eyeglass-mounted type image display device that includes an eyepiece optical unit being arranged within a field of view of one eyeball of an observer and an image display unit having a display element for displaying an image and causes an image light emitted from an image display unit to be incident on the eyeball of observer through an eyepiece optical unit, wherein at least one of the image display unit and the eyepiece optical unit is fixed and held to a hinge unit that foldably supports a temple for a pair of eyeglasses with respect to a frame.

In the eyeglass-mounted type image display device having the aforementioned structure, it is preferable that the image display unit and the eyepiece optical unit are separated. In addition, it is preferable that the image display unit is fixed and held to the hinge unit and the temple side of the pair of eyeglasses, and the eyepiece optical unit is fixed and held to the hinge unit and the lens side of the pair of eyeglasses.

It is preferable that at least one of the image display unit and the eyepiece optical unit is provided with a positioning member, and the positioning member can be an attachment structure that is attachable and detachable to and from the temple for the pair of eyeglasses or to and from at least either the image display unit or the eyepiece optical unit.

It is possible to apply a light guiding unit that guides an image light from the image display unit. In addition, instead of the light guiding unit, it is possible to apply a reflecting member that reflects off the image light from the image display unit to be incident on the eyeball of the observer. In the case where the light guiding unit is applied as the eyepiece optical unit, the light guiding unit having an entering end through which the image light emitted from the image display panel enters after passing outside the eyeglass lens and an exit end through which the image light passing through the optical path exits toward the eyeball of the observer through the eyeglass lens.

The image display unit is arranged on the temple side of the pair of eyeglasses and the eyepiece optical unit is arranged on the lens side of the pair of eyeglasses. Then the image display unit is fixed and held to the hinge unit and the temple side of the pair of eyeglasses, and the eyepiece optical unit is fixed and held to the hinge unit and the lens side of the pair of eyeglasses, thereby enabling application to the existing pair of eyeglasses without making the structure complicated or increasing the number of components and compact housing as well because the image display device does not get in the way when the temple is folded. Further, mounting of the image display device on the hinge unit can minimize the displacement (change in angle of the image display unit caused by the deflection of the temple) due to the individual difference of face breadth and the like.

The eyepiece optical unit is separated from the image display unit, thereby keeping the installation attitude of the eyepiece optical unit in front of the lens when the temple is folded. Thus the eyepiece optical unit will not project from the eyeglass. In addition, the separated structure permits the display element that displays the image light to be located near the hinge unit, thereby reducing optical “blur”.

At least one of the image display unit and the eyepiece optical unit is provided with a positioning member, thereby enabling application to the various types of pair of eyeglasses (depending on the interpupillary distance of the user). Specifically, the positioning member has an attachment structure, thereby making attachment and detachment of the image display unit easy.

The reflecting unit such as a concave mirror is applied as an eyepiece optical unit, thereby enabling reduction in size of the image display unit and simplification of the structure.

In addition, when the image light transmits through the eyeglass lens and enters into the entering end of the eyepiece optical unit (light guiding unit), the image quality of the display image declines significantly since there are many kinds of eyeglass lenses. On the other hand, when the image light that exits through the exit end of the light guiding unit is incident on the eyeball of the observer without transmitting through the lens, a separate eyesight adjusting mechanism is needed since the observer cannot see the display image with corrected eyesight. So, when the eyepiece optical unit (light guiding unit) is arranged so that the image light emitted from the image display panel passes outside the eyeglass lens and enters into the entering end and the image light that exits through the exit end transmits through the eyeglass lens and is incident on the eyeball of the observer, deterioration of the image quality can be prevented and the adjusting mechanism of eyesight is not required.

### BRIEF DESCRIPTION OF THE DRAWING

FIG. 1 is an appearance perspective view showing a state in which an eyeglass-mounted type image display device in accordance with the present invention is mounted on an existing pair of eyeglasses.

FIG. 2 is a diagram (perspective view) showing a back face of FIG. 1.

FIG. 3 is a diagram showing a plane face of FIG. 1.

FIG. 4 is a diagram showing a pair of eyeglasses equipped with the image display device in a state where a temple is folded.

FIG. 5 is a diagram showing another embodiment of the image display device in accordance with the present invention.

FIG. 6 is a diagram illustrating an operation of a positioning mechanism.

FIG. 7 is a diagram illustrating another example of the positioning mechanism.

FIG. 8 is a diagram illustrating still another example of the positioning mechanism.

FIG. 9A is a diagram illustrating the operation of the positioning mechanism to which a ball joint is added.

FIG. 9B is a diagram illustrating the operation of the positioning mechanism to which a ball joint is added.

FIG. 10 is a diagram showing yet still another example of the positioning mechanism.

FIG. 11 is a diagram showing still another embodiment of the image display device in accordance with the present invention.

FIG. 12 is a diagram showing a back face of FIG. 11.

FIG. 13 is a diagram showing a plane face of FIG. 11.

FIG. 14 is an appearance perspective view of a light guiding unit.

FIG. 15 is a diagram showing a state where a temple is folded.

FIG. 16 is an enlarged view of main parts of a hinge unit.

FIG. 17 is a diagram showing yet still another embodiment of the image display device in accordance with the present invention.

FIG. 18 is a diagram showing a front face of FIG. 17.

FIG. 19A is a diagram showing a preferable area in which a display element is arranged.

FIG. 19B is a diagram showing a preferable area in which a display element is arranged.

FIG. 19C is a diagram showing a preferable area in which a display element is arranged.

FIG. 20 is a diagram illustrating a displacement state of installation position of the display element.

FIG. 21 is a diagram illustrating a displacement state of installation position of the display element.

FIG. 22 is a diagram illustrating a displacement state of installation position of the display element.

### DESCRIPTION OF THE PREFERRED EMBODIMENTS

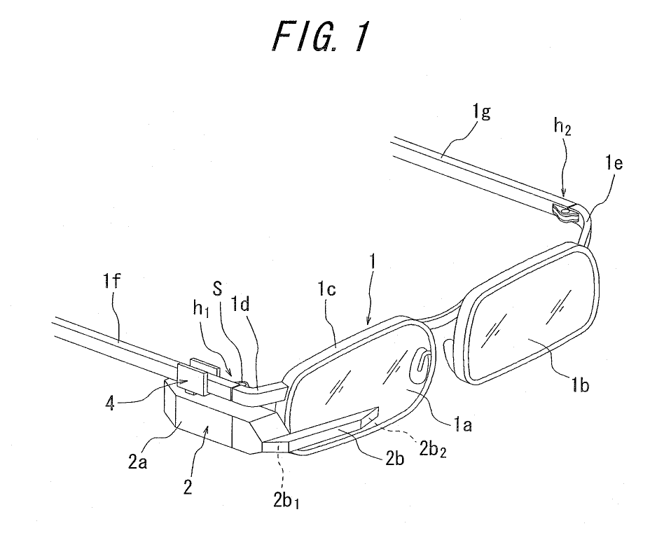

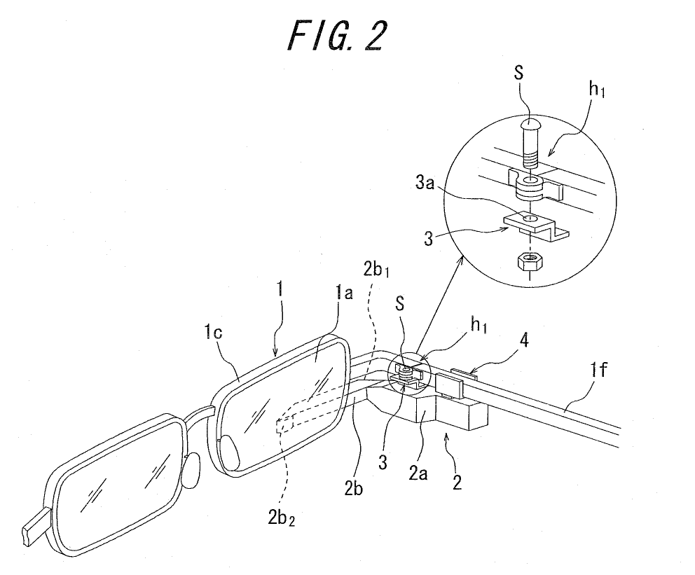

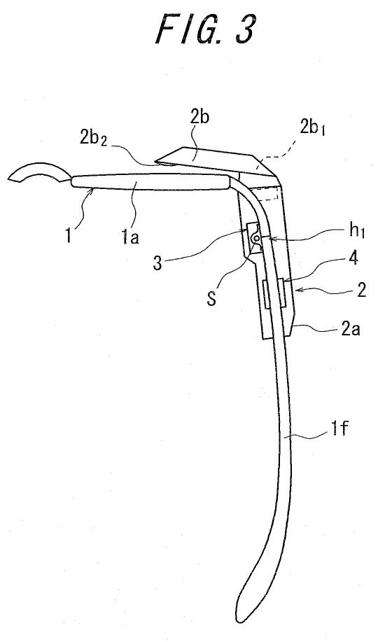

The present invention is concretely illustrated below with reference to the drawings. FIG. 1 is an appearance perspective view (right eye type) that exemplarily shows a state where an embodiment of the image display device in accordance with the present invention is mounted on an existing pair of eyeglasses. FIG. 2 is a diagram showing a back face (perspective view) of FIG. 1, and FIG. 3 is a diagram showing a plane face of FIG. 1.

1 in FIGS. 1 to 3 is a pair of eyeglasses. The pair of eyeglasses 1 is constituted by lenses 1a and 1b, a frame 1c that holds the lenses 1a and 1b, endpieces 1d and 1e that are integrally coupled respectively to the ends of left and right widths of the frame 1c, and temples 1f and 1g foldably coupled to the endpieces 1d and 1e via hinge units h1 and h2.

In addition, 2 is an image display device mounted on the pair of eyeglasses 1. The image display device 2 is constituted by an image display unit 2a provided with a display element (an image display panel such as a liquid crystal or an organic EL) for displaying the image and an eyepiece optical unit 2b that is integrally coupled to the edge of the image display unit 2a. The image display unit 2a is arranged on the temple 1f side and the eyepiece optical unit 2b is arranged so that it comes within the range of the field of view of one of the eyeballs of the observer in front of the lens 1a. Herein, a rod-shaped light guiding unit (an eyepiece lens having a curvature depending on the virtual image position that displays the image by the image light is arranged on the exit end 2b2) having an entering end 2b1 on one end thereof and an exit end 2b2 on another end thereof and other part being treated with a surface finishing (coating and the like) to prevent external light from entering into the unit is applied as an example of the eyepiece optical unit 2b.

3 is a linkage piece (both integral coupling and coupling by use of a means such as screw are possible) provided on the outer surface (upper wall face) of the case of the image display unit 2a. An opening hole (clearance hole) 3a through which a pivot pin (screw) S of the hinge unit h1 passes is formed (see the enlarged view of FIG. 2) in the linkage piece 3, and the image display unit 2a, together with the eyepiece optical unit 2b, is rotatably fixed and held to the hinge unit h1 by passing the pivot pin S through the opening hole 3a and tightening it with a nut and the like.

In addition, 4 is a clamp provided on the outer surface (upper wall face) of the case of the image display unit 2a. The clamp 4 prevents the image display unit 2 from rotating around the pivot pin S and fixes and holds the image display unit 2a to the temple 1f. The clamp 4 is constituted by a holding piece in a U-shape in cross section that sandwiches the temple 1f from both sides. As a result of this, the image display unit 2a is fixed and held to the hinge unit h1 and the temple side.

The aforementioned image display device 2 is fixed and held to two parts by use of the pivot pin S (a screw with a diameter of about 1.4 mm is used for the normal pair of eyeglasses) provided on the hinge unit h1 and the clamp 4, thereby making it easy to apply to an existing pair of eyeglasses.

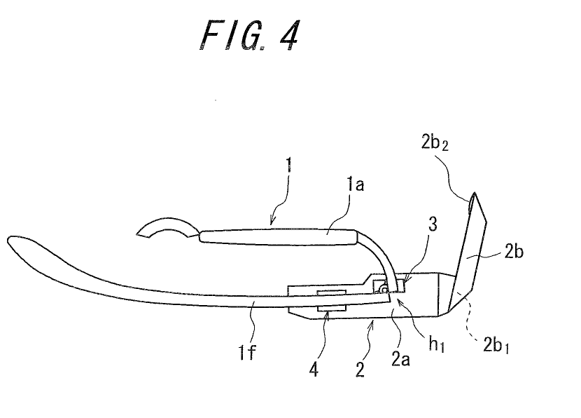

The opening hole 3a of the linkage piece 3 used to fix and hold the image display device 2 is a clearance hole. Therefore, as shown in FIG. 4, the temple if can be folded without any interference. At this time, the image display unit 2a moves in conjunction with the movement of the temple 1f, thereby finishing the housing with one operation.

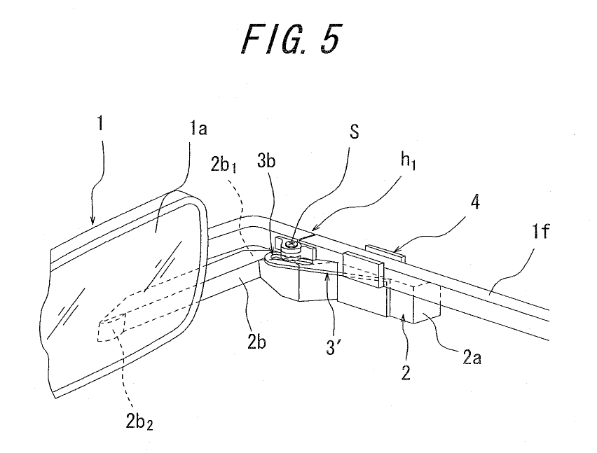

FIG. 5 is a diagram showing another embodiment in accordance with the present invention that illustrates an example of the positioning member constituted by the linkage piece (linkage piece 3′ having a long hole 3b) in which the long hole 3b is formed instead of the opening hole 3a.

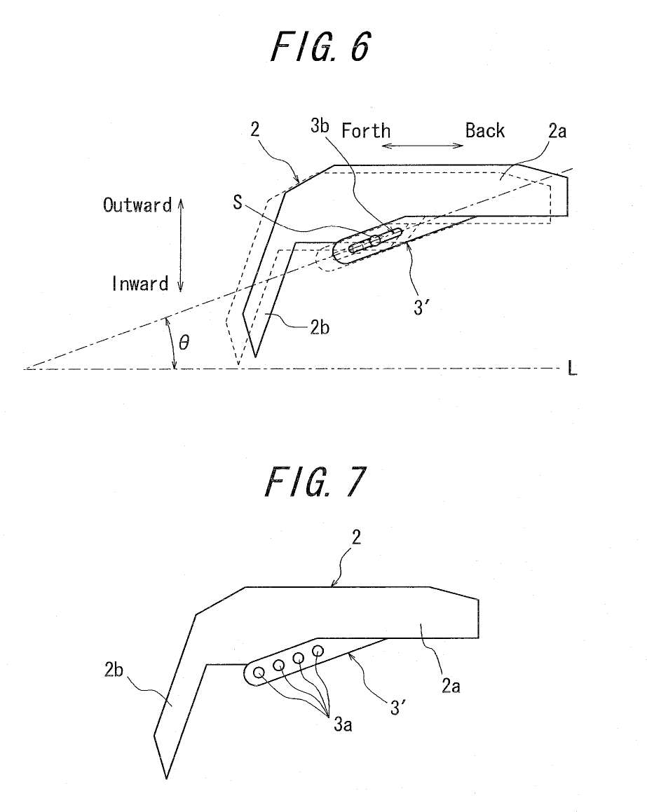

As in the case of the opening hole 3a, the pivot pin S of the hinge unit h1 passes through the long hole 3b, and this part fixes and holds the image display unit 2a. This structure enables the image display device 2 to slide back and forth within the range of the long hole 3b, as shown in FIG. 6, by loosening the nut that is engaged with the pivot pin S through the screw (the position is fixed by tightening the nut). Thus positioning of the image display device 2 within the horizontal plane can be performed easily (appropriate positioning of the eyepiece optical unit 2b with respect to the lens 1a can be performed) even if the position of the hinge unit h1 varies depending on the pair of eyeglasses.

With respect to the positioning member 3′, as shown in FIG. 7, it is possible to arrange a plurality of opening holes 3a. In this regard, occasional changes are possible. Specifically, in the case where the long hole 3b is provided or a plurality of opening holes 3a are arranged to perform positioning of the image display device 2 in a front-to-back direction, it is preferable to apply an inclination so that the front end of the linkage piece 3′ inclines inwardly at an angle of θ=5 to 25 degrees with respect to the axis line L (see FIG. 6) that divides the pair of eyeglasses into left and right in the width direction in the center. This is because, with respect to the hinge unit h1 of the pair of eyeglasses, in general, when it is located near the lens, it is located inward of the pair of eyeglasses in the width direction, and as the distance between it and the lens becomes larger, it tends to be located outward of the pair of eyeglasses in the width direction. Thus by applying angle of θ=5 to 25 degrees, application to an existing pair of eyeglasses will become easier.

In the case where the positioning member 3′ that is constituted as described above is applied, the clamp 4 is rotatably connected to the image display unit 2a so that the mounting angle thereof can be changed according to the change of the angle of the image display unit 2a.

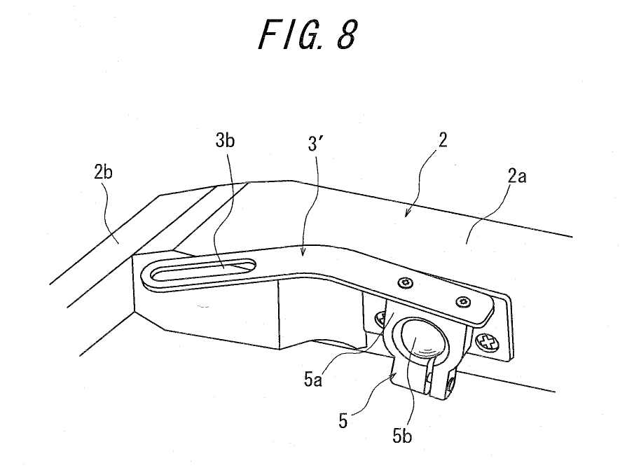

As for the positioning member 3′ constituted by the linkage piece 3, a ball joint 5 can be added thereto. FIG. 8 shows an example in which the outer surface of the case of the image display unit 2a is provided with the ball joint 5, and the back end of the linkage piece 3 is coupled to the receiving member 5a of the ball joint 5.

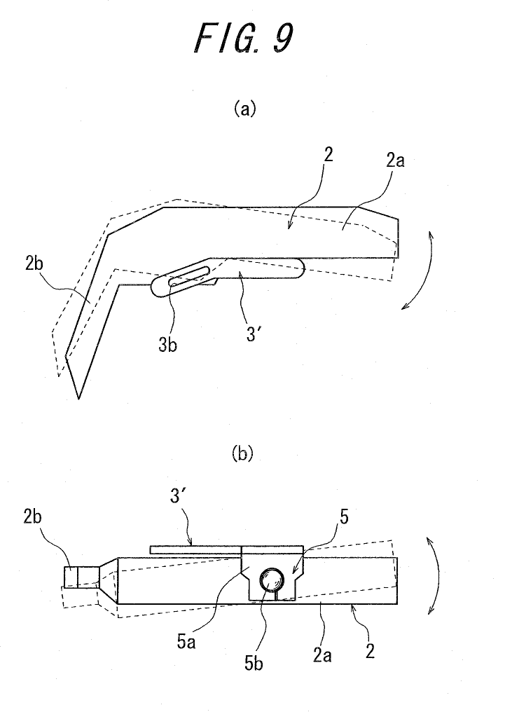

In the image display device 2 having such structure, as shown in FIGS. 9A and 9B, in addition to the positioning in a front-to-back direction (positioning within the horizontal plane) by use of the long hole 5, vertical angle adjustment is possible. Thus the degree of freedom of the positioning range of the image display device 2 is further expanded.

For the ball joint 5 that constitutes the aforementioned positioning member 3′, although not shown in the figure, it can be an attachment structure that is occasionally attachable and detachable to and from the image display unit 2a and the like. In order to fix the image display unit 2a at a predetermined angle when the ball joint 5 is applied, the ball 5b may be fixed to the receiving member 5a by tightening the screw provided at the receiving member 5a of the ball joint 5.

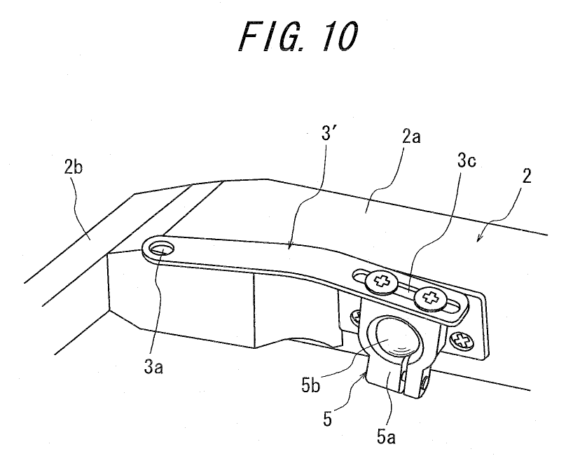

In addition, as shown in FIG. 10, the positioning member 3′ has a long hole 3c formed in the back end of the linkage piece 3, and the linkage piece 3 may be fixed to the receiving member 5a of the ball joint 5 with the screws by use of the long hole 3c. In this case, the position of the image display unit 2a can be adjusted in a front-to-back direction by use of the long hole 3c, and the front end of the linkage piece 3 is provided with the opening hole 3a through which the pivot pin S passes.

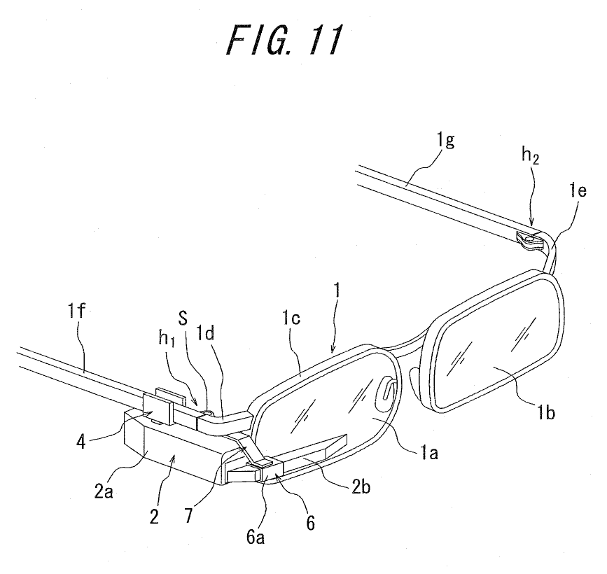

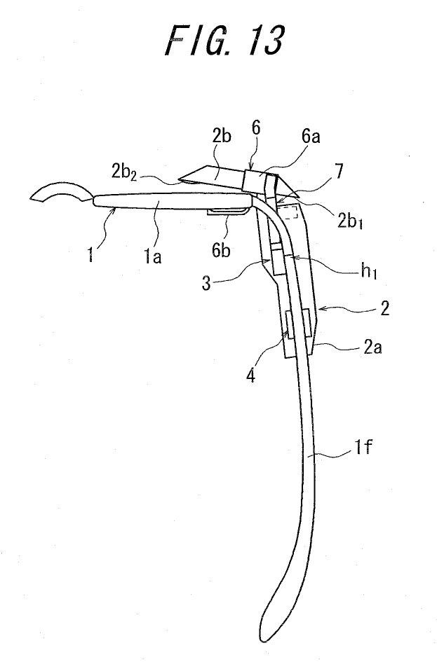

FIGS. 11 to 13 show another embodiment in accordance with the present invention in which the image display unit 2a and the eyepiece optical unit 2b are separated (divided structure) and are mounted on the existing pair of eyeglasses.

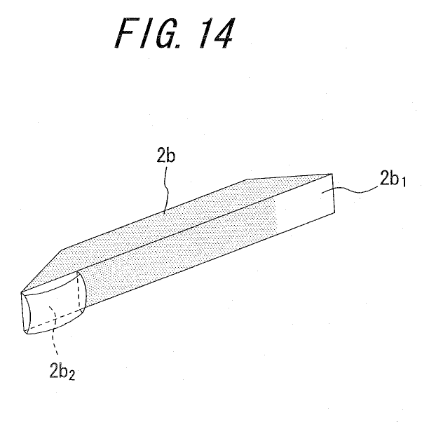

The eyepiece optical unit 2b applied by this example has a divided structure that is constituted separately from the image display unit 2a and is shown as a rod-shaped light guiding unit (an eyepiece lens having a curvature depending on the virtual image position that displays an image by the image light is arranged on the exit end 2b2, which is basically the same as those shown in FIGS. 1 to 5), as shown in FIG. 14, having the entering end 2b1 formed on one end thereof and the exit end 2b2 formed on another end thereof and other part being treated with a surface finishing (coating and the like) to prevent external light from entering into the unit. The image light emitted from the display element of the image display unit 2a through the window hole is incident toward the eyeball of the observer after passing through the entering end 2b1, the light guiding path and the exit end 2b2 of the eyepiece optical unit 2b (the light guiding unit 2b is arranged so that the entering end 2b1 is located on the outward side of the lens 1a and the exit end 2b2 is located in front of the lens 1a of the eyeglass).

Such eyepiece optical unit 2b is held by the holder 6 as shown in FIGS. 11 to 13. The holder 6 is constituted by a box-shaped body unit 6a that surrounds the eyepiece optical unit 2b and a cantilever-support type elastic tongue piece 6b that is integrally provided at the body unit 6a. The elastic tongue piece 6b is located on the back side of the lens 1a, which is sandwiched (clipped) between the elastic tongue piece 6b and the eyepiece optical unit 2b that is held by the holder 6, thereby positioning the eyepiece optical unit 2b in front of the lens 1a.

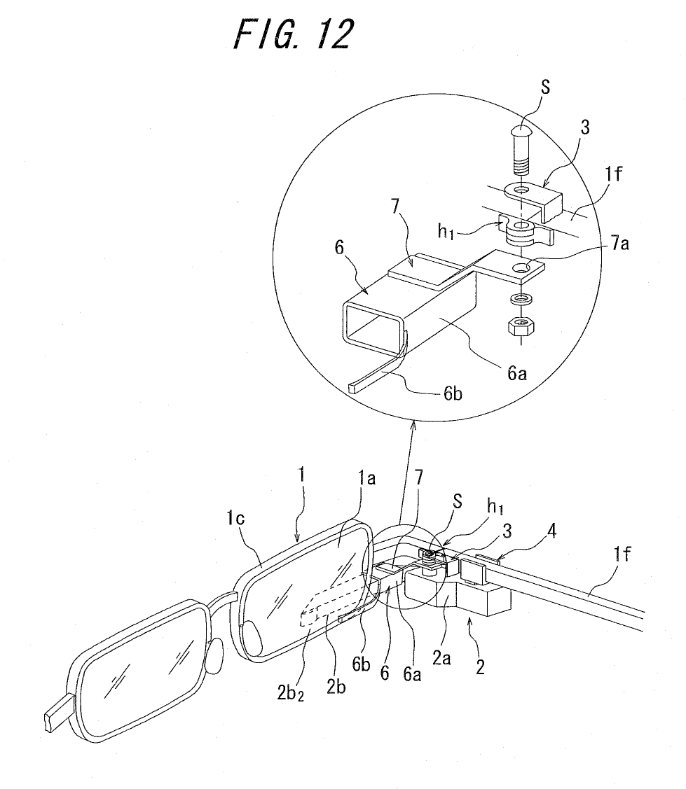

In addition, 7 in FIGS. 11 to 13 is a locking piece and one end thereof is coupled to the holder 6. The locking piece 7, as an exploded perspective view of the main units thereof is shown in FIG. 12, has an opening hole (clearance hole) 7a formed on another end thereof, and is rotatably linked to the pivot pin S of the hinge unit h1 via the opening hole 7a, thereby fixing and holding the eyepiece optical unit 2b to the hinge unit h1 by the locking piece 7 and stably keeping the attitude of the eyepiece optical unit 2b with respect to the lens 1a.

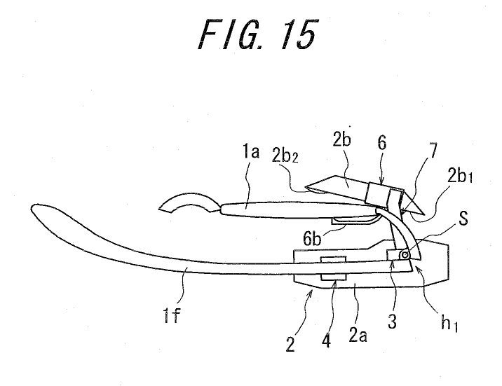

In the image display device 2 having the aforementioned structure, the eyepiece optical unit 2b is fixed and held to the hinge unit h1 and the lens side by the elastic tongue piece 6b of the holder 6 and the linkage piece 7, and the attitude of the eyepiece optical unit with respect to the lens 1a is kept as shown in FIG. 15 even in a housing state where the temple 1f is folded. Thus compact housing is possible.

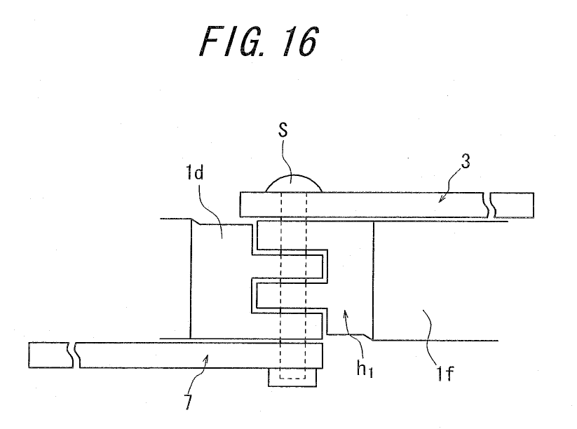

FIG. 16 is an enlarged view of the main parts of the hinge unit h1. Specifically, when the image display device having a divided structure (separate type) as shown in FIGS. 11 to 13 is mounted on the existing pair of eyeglasses, it is preferable that the linkage piece 3 for fixing and holding the image display unit 2a is located on the upper end or the lower end of the temple 1f (in the example in the figure, the linkage piece 3 is located on the upper end of the temple 1f) and the locking piece 7 for fixing and holding the eyepiece optical unit 2b is located on the upper end or the lower end of the endpiece 1d (in the example, the locking piece 7 is located on the lower end of the endpiece 1d). Thus the image display unit 2a moves in conjunction with the eyepiece optical unit 2b and the eyepiece optical unit 2b moves in conjunction with the lens 1a, thereby allowing a smooth folding.

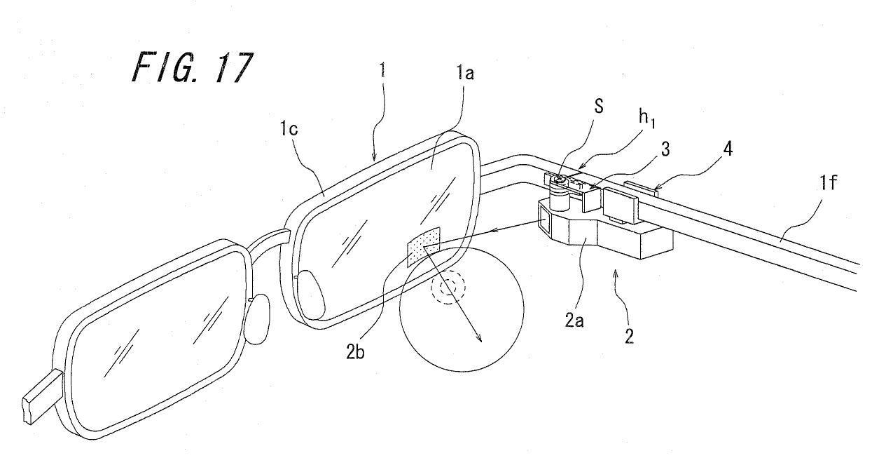

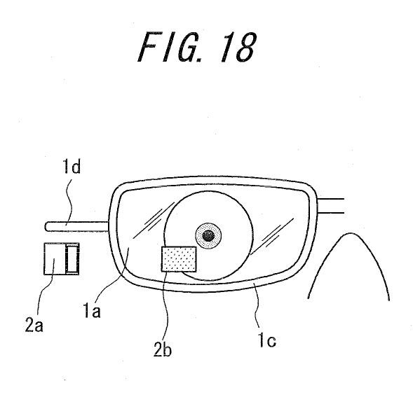

FIGS. 17 and 18 show still another embodiment of the present invention in which the image display unit 2a and the eyepiece optical unit 2b are separated and are mounted on the existing pair of eyeglasses.

In this example, the lens 1a for the pair of eyeglasses is provided with a reflecting member constituted by a concave mirror and the like as an eyepiece optical unit 2b, and the image light emitted from the display element of the image display unit 2a through the window hole 2c is incident on the eyeball of the observer by way of the reflecting member.

In the image display device 2 having such structure, the eyepiece optical unit 2b that serves as a reflecting member can be arranged at the lens 1a for the pair of eyeglasses (it can be arranged either in front of or on back side of the lens, however, it can be mounted directly on the lens) or at the frame and the like. Thus the installation range of the eyepiece optical unit 2b is relatively free (wide adjustment range), and the eyepiece optical unit 2b can be pasted, thereby enabling simplification of the structure.

The installation position of the image display unit 2a is determined so that the display element that emits the image light is located near the hinge unit h1. This is because, considering the wearing state of the pair of eyeglasses, the width of the head and the like varies from observer to observer and thus the amount of deflection of the temple varies depending on the width of head and the like of the observer. However, since the deflection of the temple occurs from the hinge unit as a starting point, the deviation of the optical axis caused by the deflection of the temple 1f can be minimized by placing the display element near the hinge unit h1.

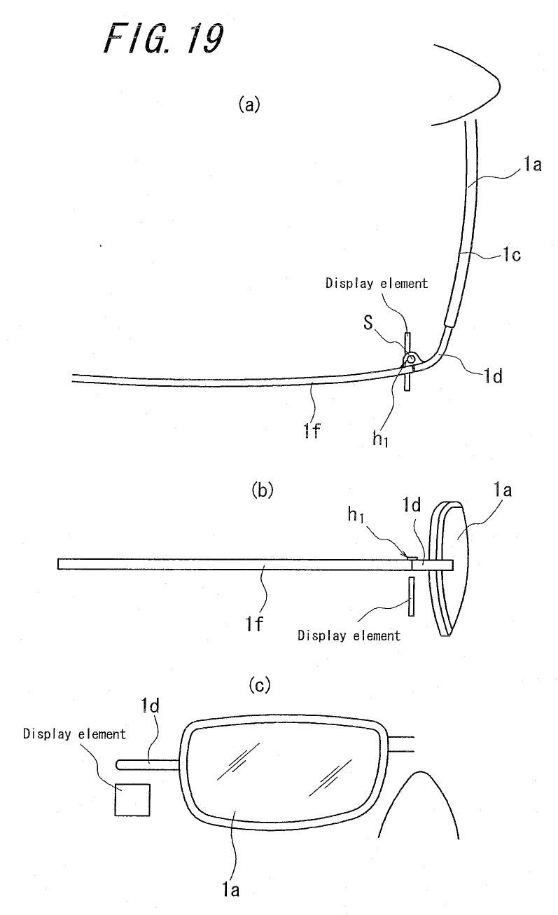

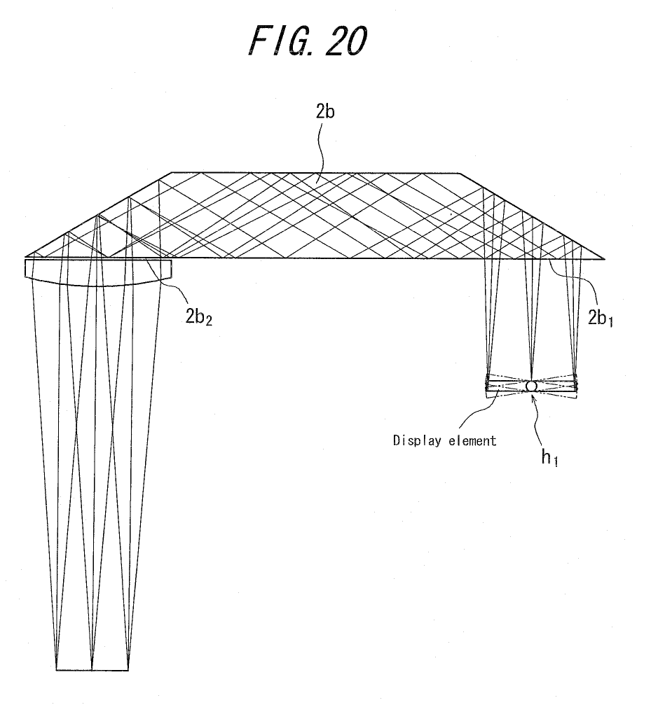

Since the display element is, whichever it is an integrated type or a separate type (divided structure), embedded into the image display unit 2a, the most preferable installation position thereof is, as shown in FIGS. 19 A to C, immediately below the hinge h1. The image display unit 2a is arranged so that the display element is located immediately below the hinge h1, thereby reducing the sideways projection of the image display device 2, which avoids not only hindering the field of view on the front side but also misalignment of the center of the display element from the exit end 2b1 (within the range of field of view) as shown in FIG. 20 even if the temple 1f bends and the display element inclines.

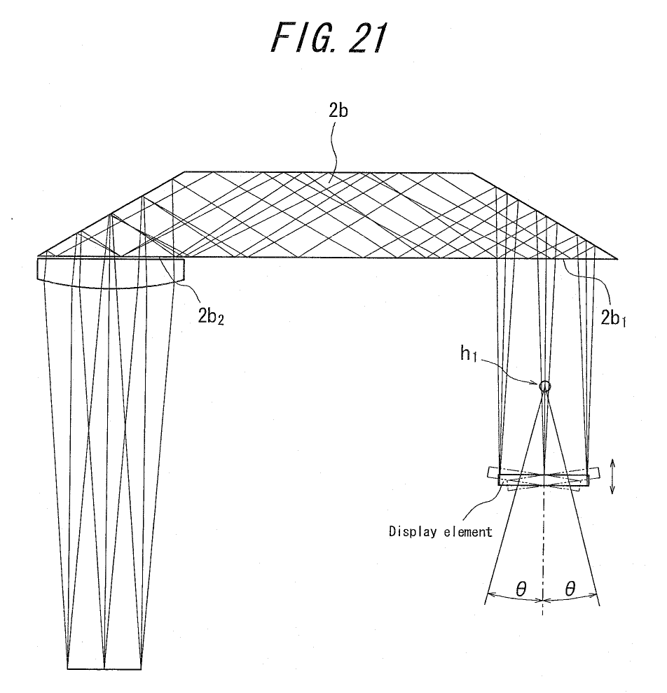

It is thought that the width dimension of the head of the adult male is within the range from 142 to 169 mm. Now suppose the length between the hinge unit h1 and the ear hook part of the temple is 90 mm, when the temple bends, the angle θ varies inward and outward by about ±4 degrees from the hinge unit h1 as a starting point as shown in FIG. 21. Here, suppose the width dimension of the display element is about 4 mm and the deviation of the optical axis can be allowed up to about 10%, 0.4 mm/tan (4 deg)=5.7 mm. Thus the display element cannot be arranged immediately below the hinge unit h1, and in the case where the display element should be arranged posterior thereof, it is preferable that the distance from the hinge unit h1 is within about 5.7 mm.

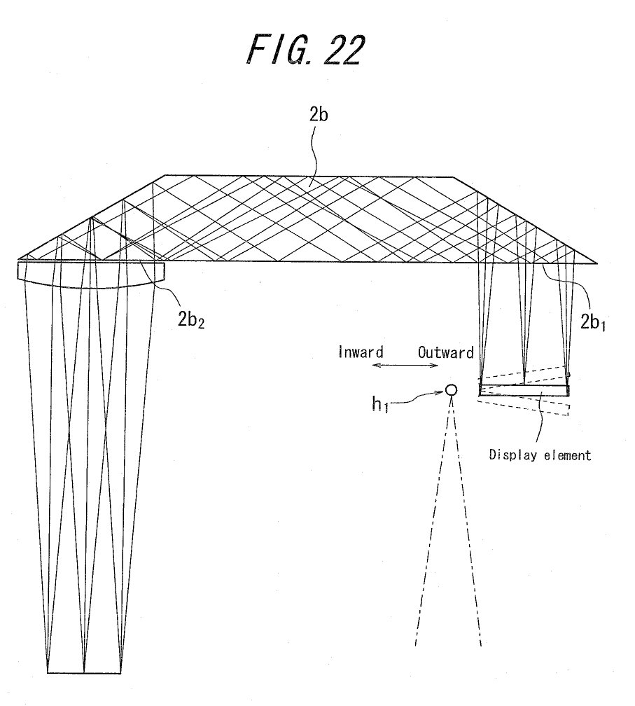

Further, as shown in FIG. 22, for displacement of the display element in the left-right direction (head width direction) from the hinge unit h1 as a starting point, the larger the distance between the display element and the center of the hinge unit h1 becomes, the larger the influence thereof becomes.

Calculating the acceptable displacement in the left-right direction based on the depth of focus, D.O.F. (the range of the image distance in relation to the back and forth range of the distance of the object included in the depth of field, that is, the tolerance of distance between the film and the lens in the range of acceptable sharpness of the focused object), ±D.O.F={(ω×250000)/(N.A.×M)}+{λ/2(N.A.)²}, where ω: eye's resolution 0.0014 (suppose the angle of sight is 5 arcminutes), M: total magnification (objective×magnification of eyepiece lens) and λ: optical wavelength (for visible light, λ=0.55 μm). Accordingly, ±D.O.F.={350/(N.A.×M)}+{0.275/(N.A.)²}. In this case, based on M=250/f (f=approx. 32 mm), M=7.8, and suppose N.A=pupil diameter/2/f=0.0625 (the larger, the N.A. becomes, the shallower the depth of focus becomes), ±D.O.F=791 μm. In the case where the inclination of approx. 4 degrees occurs due to deflection of the temple 1f when the pair of eyeglasses is worn, the range which is the farthest from the hinge h1 but is within the depth of focus is 791/tan(4 deg)=11.3 mm. Suppose the width dimension of the display element is 4 mm, 11.3−4/2=9.3 mm. Therefore the allowable range of displacement in the width direction is ±9.3 mm. Consequently, in the case where displacement of the display element in the width direction is unavoidable or the display element should be displaced previously, it is preferable that the display element is placed within the range of ±9.3 mm from the center of the hinge unit h1.

In addition, with respect to the separate type image display device 2, the positioning member is constituted by providing the linkage piece 3 that is fixed and held to the hinge unit h1 by using the long hole 3b and by applying the means such as the ball joint 5 as well, thereby performing positioning and angle adjustment within the horizontal plane. In this regard, no specific restriction is provided. Further, for the function of angle adjustment within the horizontal plane, which is not shown, a retainer may have such function, or the image display unit 2a may rotatably coupled to the pivot pin S of the hinge unit h1 directly.

### INDUSTRIAL APPLICABILITY

An eyeglass-mounted type image display device that enables easy application to an existing pair of eyeglasses and compact housing can be provided.

What is claimed is:

1. An eyeglass-mounted type image display device that comprises an eyepiece optical unit being arranged within a field of view of one eyeball of an observer and an image display unit having a display element for displaying an image and causes an image light emitted from the image display unit to be incident on the eyeball of the observer through the eyepiece optical unit, wherein
at least one of the image display unit and the eyepiece optical unit is fixed and held to a hinge unit that foldably supports a temple for a pair of eyeglasses with respect to a frame.

2. The eyeglass-mounted type image display device according to claim 1, wherein
the image display unit and the eyepiece optical unit have a separate structure respectively.

3. The eyeglass-mounted type image display device according to claim 1, wherein
the image display unit is fixed and held to the hinge unit and the temple side of the pair of eyeglasses.

4. The eyeglass-mounted type image display device according to claim 1, wherein
the eyepiece optical unit is fixed and held to the hinge unit and a lens side of the pair of eyeglasses.

5. The eyeglass-mounted type image display device according to claim 1, wherein
at least one of the image display unit and the eyepiece optical unit has a positioning member.

6. The eyeglass-mounted type image display device according to claim 5, wherein
the positioning member has an attachment structure that is attachable and detachable to and from a temple for a pair of eyeglasses or at least one of the image display unit and the eyepiece optical unit.

7. The eyeglass-mounted type image display device according to claim 1, wherein
the eyepiece optical unit is constituted by a light guiding unit that guides an image light from the image display unit.

8. The eyeglass-mounted type image display device according to claim 7, wherein
the light guiding unit has an entering end through which the image light having been emitted from an image display panel and having passed outside an eyeglass lens enters and an exit end through which the image light having passed through an optical path exits toward an eyeball of an observer though an eyeglass lens.

9. The eyeglass-mounted type image display device according to claim 1, wherein
the eyepiece optical unit is constituted by a reflecting member that reflects off the image light from the image display unit.
